(19) United States
(12) Patent Application Publication
(10) Pub. No.: US 2022/0358426 A1
(43) Pub. Date: Nov. 10, 2022

(54) PREDICTION METHOD AND PREDICTION DEVICE FOR FOOD SAFETY RISK LEVEL AND ELECTRONIC APPARATUS

(71) Applicant: HUBEI PROVINCIAL INSTITUTE FOR FOOD SUPERVISION AND TEST, Wuhan (CN)

(72) Inventors: Hong Wen, Wuhan (CN); Ning Xu, Wuhan (CN); Li Chen, Wuhan (CN); Jia Yin, Wuhan (CN); Xiang Chen, Wuhan (CN); Man Dong, Wuhan (CN); Pengcheng Guo, Wuhan (CN)

(21) Appl. No.: 17/609,175

(22) PCT Filed: Jul. 14, 2021
(86) PCT No.: PCT/CN2021/106249

§ 371 Date: Nov. 5, 2021

(30) Foreign Application Priority Data
Dec. 7, 2020 (CN) 2020-11461921.X

(51) Int. Cl. G06Q 10/06; G06K 9/62

(52) U.S. Cl. CPC G06Q 10/0635; G06K 9/6277

(57) ABSTRACT

The present application provides a prediction method and a prediction device for food safety risk level and an electronic apparatus. The method includes: classifying food safety risk level based on historical test data for food safety, to obtain historical data for food safety risk level; performing wavelet decomposition on the historical data for food safety risk level based on Daubechies wavelet basis, to obtain a plurality of historical data components for food safety risk level; and inputting the plurality of historical data components for food safety risk level into an LSTM model and predicting a food safety risk level, to obtain a predicted value of the food safety risk level. By the prediction method and the prediction device for food safety risk level and the electronic apparatus according to the present application, the food safety risk level may be effectively predicted.

### CROSS-REFERENCE TO RELATED APPLICATION

The present application claims priority to Chinese patent application No. 202011461921.X filed on Dec. 07, 2020, entitled “Prediction Method and Prediction Device for Food Safety Risk Level and Electronic Apparatus”, which is hereby incorporated by reference in its entirety.

### FIELD OF TECHNOLOGY

The present application relates to the technical field of food safety, and in particular to a prediction method and a prediction device for food safety risk level and an electronic apparatus.

### BACKGROUND

Soy-cured and pot-stewed meat product is one of the traditional meat products in China, with unique flavor and high nutritional value, which is very popular among consumers and whose safety issue directly affects the health of the general public. Food safety involves the entire process of a food supply chain. There are potential factors that threaten food safety from supply of raw materials, production and processing of foods, circulation of foods and other links, and thus risk factors of the respective links need to be taken into account for risk assessment and supervision of food safety. Therefore, it is very necessary to excavate and analyze these factors, make full use of these complex data, extract potentially valuable information, identify potential safety risks according to characteristics of different food safety data, conduct integrated and dynamic early warning studies, issue timely warnings of problematic foods or possible risks, and provide technical supports for food safety risk supervisory departments in risk control.

Although the main research methods for risk prediction of food safety are BP artificial neural networks and support vector machines, BP artificial neural networks and support vector machines have such disadvantages as long training time, unstable network training efficiency, and low accuracy in the view of prediction of food safety. For massive supervision and sampling data, the supervision organization usually obtain a failure rate of a kind of food through simple statistical analysis of historical sampling data set for food safety, and then use this indicator to evaluate the food safety status of this kind of food. Such method carries out a post-analysis of the food safety status. However, food safety test data over the years often has a large number of empty values, which means that certain items have not been tested or there are no test results after being tested. It is impossible for the mathematical statistics method to carry out risk assessment on the empty values and find relationship between data items.

### BRIEF SUMMARY

With respect to the above technical problems in the prior art, the present application provides a prediction method and a prediction device for food safety risk level and an electronic apparatus.

In a first aspect, the present application provides a prediction method for food safety risk level including: classifying food safety risk level based on historical test data for food safety, to obtain historical data for food safety risk level;

performing wavelet decomposition on the historical data for food safety risk level based on Daubechies wavelet basis, to obtain a plurality of historical data components for food safety risk level; and

inputting the plurality of historical data components for food safety risk level into an LSTM model and predicting a food safety risk level, to obtain a predicted value of the food safety risk level.

In an embodiment, the inputting the plurality of historical data components for food safety risk level into an LSTM model and predicting a food safety risk level, to obtain a predicted value of the food safety risk level includes:

predicting the plurality of historical data components for food safety risk level respectively by the LSTM model, to obtain predicted results of the plurality of historical data components for food safety risk level; and

reconstructing the predicted results of the plurality of historical data components for food safety risk level, to obtain a predicted value of the food safety risk level.

In an embodiment, the classifying food safety risk level based on historical test data for food safety, to obtain historical data for food safety risk level includes:

de-dimensionalizing the historical test data for food safety to obtain de-dimensionalized historical test data for food safety; and

classifying food safety risk level based on the de-dimensionalized historical test data for food safety to obtain the historical data for food safety risk level.

In an embodiment, the food safety risk level is classified into 5 levels;

the classifying food safety risk level based on the de-dimensionalized historical test data for food safety to obtain historical data for food safety risk level is specifically:

$${Y}_{i} = \{ \begin{matrix}{X}_{i} / {X}_{standard} , & when {X}_{standard} is a numerical value , \\ 0 , & when {X}_{standard} is not to be detected or not to be used , and the measured value of the item is not detected \\ 1 , & when {X}_{standard} is not to be detected or not to be used , and the measured value of the item has a numerical value\end{matrix}$$

where Yᵢ is the de-dimensionalized historical test data for food safety, X_{standard} is a standard value specified in the national standards, and Xᵢ is the actual measured value of a test item; and

when Yᵢ is greater than or equal to zero and less than or equal to 0.1, the food safety risk level is 1; when Yᵢ is greater than 0.1 and less than or equal to 0.3, the food safety risk level is 2; when Yᵢ is greater than 0.3 and less than or equal to 0.7, the food safety risk level is 3; when Yᵢ is greater than 0.7 and less than 1, the food safety risk level is 4; when Yᵢ is greater than 1, the food safety risk level is 5.

In an embodiment, after classifying food safety risk level based on the historical test data for food safety based on historical test data for food safety to obtain historical data for food safety risk level, the method further includes:

binning the historical data for food safety risk level based on a predetermined time interval to obtain binned historical data for food safety risk level; and

obtaining historical data for integrated risk level of food based on the binned historical data for food safety risk level.

In an embodiment, the obtaining historical data for integrated risk level of food based on the binned historical data for food safety risk level is calculated by the following equation:

level(A)=argmax[w(i)*eⁱ]+1

where level(A) is an integrated risk level of food A; i is the risk level of food A, and w(i) is a proportion of risk level i in food A.

In a second aspect, the present application provides a prediction device for food safety risk level, including:

a risk level classifier configured to classify food safety risk level based on historical test data for food safety to obtain historical data for food safety risk level;

a decomposer configured to perform wavelet decomposition on the historical data for food safety risk level based on Daubechies wavelet basis to obtain a plurality of historical data components for food safety risk level; and

a processor configured to input the plurality of historical data components for food safety risk level into an LSTM model and predict a food safety risk level to obtain a predicted value of the food safety risk level.

In an embodiment, the processor is configured to input the plurality of historical data components for food safety risk level into an LSTM model and predict a food safety risk level to obtain a predicted value of the food safety risk level, which specifically includes:

predicting the plurality of historical data components for food safety risk level respectively by the LSTM model, to obtain predicted results of the plurality of historical data components for food safety risk level; and

reconstructing the predicted results of the plurality of historical data components for food safety risk level, to obtain a predicted value of the food safety risk level.

In a third aspect, the present application also provides an electronic apparatus, including a memory, a processor, and computer programs stored on the memory and executable on the processor, the processor is configured to implement steps of the method provided in the first aspect when executing the computer programs.

In a fourth aspect, the present application provides a non-transitory computer-readable storage medium in which computer programs are stored, and when the computer programs are executed by a processor, the steps of the method provided in the first aspect are implemented.

In the prediction method and the prediction device for food safety risk level and the electronic apparatus provided by the present application, historical data for food safety risk level are obtained based on historical test data for food safety, the historical data for food safety risk level is input into an LSTM model for prediction of the food safety risk level, and the prediction of the food safety risk level is effectively achieved. Also, considering that the sampling data for food safety is a non-stationary discrete time series with large amplitude, if it is directly brought into the LSTM model, the learning effect will be poor and the prediction accuracy will be affected. Therefore, before being brought into the LSTM model, the historical test data for food safety is preprocessed to be smoothed by wavelet decomposition, thereby further improving the prediction accuracy and providing technical support for the defense and daily monitoring of food safety.

### BRIEF DESCRIPTION OF THE DRAWINGS

In order to more clearly illustrate technical solutions in the present application or the prior art, the drawings needed to be used in the descriptions of the embodiments or the prior art will be briefly introduced below. Obviously, the drawings in the following description are some embodiments of the present application, and other drawings can be obtained according to the drawings for those skilled in the art without any creative work.

FIG. 1 is a first flow diagram of a prediction method for food safety risk level according to the present application;

FIG. 2 is a structural diagram of a wavelet decomposition according to the present application;

FIG. 3 is a structural diagram of an LSTM model according to the present application;

FIG. 4 is a second flow diagram of a prediction method for food safety risk level according to the present application;

FIG. 5 is a structural diagram of a prediction device for food safety risk level according to the present application; and

FIG. 6 is a structural diagram of an electronic apparatus according to the present application.

### DETAILED DESCRIPTION

In order to make the objectives, technical solutions and advantages of the present application clearer, the technical solutions in the present application will be described clearly and completely in conjunction with the accompanying drawings in the present application. Obviously, the described embodiments are part of the embodiments of the present application, rather than all of the embodiments. All other embodiments obtained by a person of ordinary skill in the art based on the embodiments of the present disclosure without any creative work belong to the protection scope of the present disclosure.

The present application provides a prediction method for food safety risk level. It is to be noted that a subject for execution of the method may be an electronic apparatus, a component, an integrated circuit, or a chip in an electronic apparatus. The electronic apparatus may be a mobile electronic apparatus and may also be a non-mobile electronic apparatus. For example, the mobile electronic apparatus may be a cell phone, a tablet computer, a notebook computer, a handheld computer, a vehicle-mounted electronic apparatus, a wearable device, an ultra-mobile personal computer (UMPC), a netbook, or a personal digital assistant (PDA), etc., and the non-mobile electronic apparatus may be a server, a network attached storage (NAS), a personal computer (PC), a television (TV), a teller machine or a self-service machine, etc., which are not specifically limited in the present application.

Taking a computer implementation of the prediction method for food safety risk level according to the present application as an example, the technical solutions of the present application are explained in detail.

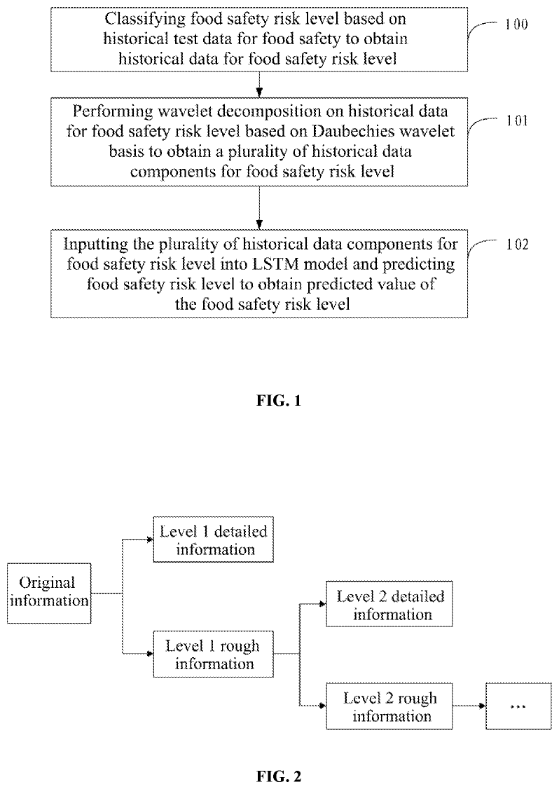

FIG. 1 is a flow diagram of a prediction method for food safety risk level according to the present application. As shown in FIG. 1, the method including:

step 101, classifying food safety risk level based on historical test data for food safety, to obtain historical data for food safety risk level.

Specifically, the historical test data for food safety may be data that is publicly available (e.g., through the internet, journals, papers, etc.) from a relevant institution (e.g., a public institution with testing qualifications, a third-party food testing institution, etc.), or may also be historical data of food testing kept internally by the relevant institution.

Taking test data for soy-cured and pot-stewed meat products available from a relevant institution during 2014 to 2019 as the historical test data for food safety as an example, the prediction method for food safety risk level according to the present application is described in detail.

The above historical test data for food safety includes the original information such as varieties, names, production dates, test items, test results, decision results, decision bases, and standard values of qualified and unqualified products, and some of the data obtained are shown in Table 1.

TABLE 1
Test data of soy-cured and pot-stewed meat products

| | | | | | | | | Standard | |
|---|---|---|---|---|---|---|---|---|---|
| | Variety | Name of | Production | Test | Test | Judgment | Judgment | Allowable | Item |
| Year | of Food | Sample | Date | Item | Result | Result | Basis | Maximum | Category |
| 2014 | soy-cured | secretly- | 2014-04-14 | sorbic | 0.016 g/kg | qualified | GB2760 | 0.075 g/kg | food |
| | and | made | | acid and | | | | | additive |
| | pot-stewed | duck | | potassium | | | | | |
| | meat | wings | | salt | | | | | |
| | product | | | thereof | | | | | |
| | | | | (in terms | | | | | |
| | | | | of sorbic | | | | | |
| | | | | acid) | | | | | |
| 2014 | soy-cured | salt & | 2014-05-16 | lead (in | 0.03 mg/kg | qualified | GB2762 | 0.5 mg/kg | heavy |
| | and | pepper | | terms of | | | | | metals |
| | pot-stewed | chicken | | Pb) | | | | | and |
| | meat | drumsticks | | | | | | | other |
| | product | | | | | | | | elemental |
| | | | | | | | | | pollutants |
| 2014 | soy-cured | duck | 2014-06-04 | sorbic | 0.19 g/kg | unqualified | GB2760 | 0.075 g/kg | food |
| | and | necks | | acid and | | | | | additive |
| | pot-stewed | (soy-cured | | potassium | | | | | |
| | meat | and | | salt | | | | | |
| | product | pot-stewed | | thereof | | | | | |
| | | meat | | (in terms | | | | | |
| | | product) | | of sorbic | | | | | |
| | | | | acid) | | | | | |
| 2015 | soy-cured | spicy | 2014-12-28 | chromium | 53.4 μg/kg | qualified | GB2762 | 1 mg/kg | heavy |
| | and | sauce | | (in | | | | | metals |
| | pot-stewed | tripe | | terms of | | | | | and |
| | meat | | | Cr) | | | | | other |
| | product | | | | | | | | elemental |
| | | | | | | | | | pollutants |
| 2016 | soy-cured | beef | 2016-01-25 | cadmium | <0.025 mg/kg | qualified | GB2762 | 0.1 mg/kg | heavy |
| | and | jerky | | (in | | | | | metals |
| | pot-stewed | (spicy) | | terms of | | | | | and |
| | meat | | | Cd) | | | | | other |
| | product | | | | | | | | elemental |
| | | | | | | | | | pollutants |
| 2016 | soy-cured | soy-cured | 2016-02-03 | nitrite | 1 mg/kg | qualified | GB2760 | 30 mg/kg | food |
| | and | pig | | residue | | | | | additive |
| | pot-stewed | feet | | (in terms | | | | | |
| | meat | | | of | | | | | |
| | product | | | sodium | | | | | |
| | | | | nitrite) | | | | | |
| 2017 | soy-cured | fine | 2016-10-10 | sorbic | 0.241 g/kg | unqualified | GB2760 | 0.075 g/kg | food |
| | and | sauce | | acid and | | | | | additive |
| | pot-stewed | pig feet | | potassium | | | | | |
| | meat | | | salt | | | | | |
| | product | | | thereof | | | | | |
| | | | | (in terms | | | | | |
| | | | | of sorbic | | | | | |
| | | | | acid) | | | | | |
| 2017 | soy-cured | soy-cured | 2016-11-02 | total | 0.68 mg/kg | unqualified | GB2762 | 0.5 mg/kg | heavy |
| | and | duck | | arsenic | | | | | metals |
| | pot-stewed | | | (in terms | | | | | and |
| | meat | | | of As) | | | | | other |
| | product | | | | | | | | elemental |
| | | | | | | | | | pollutants |
| 2018 | soy-cured | pot-stewed | 2017-11-10 | nitrite | 71 mg/kg | unqualified | GB2760 | 30 mg/kg | food |
| | and | duck | | residue | | | | | additive |
| | pot-stewed | | | (in terms | | | | | |
| | meat | | | of | | | | | |
| | product | | | sodium | | | | | |
| | | | | nitrite) | | | | | |
| 2019 | soy-cured | minced | 2018-02-24 | total | 0.042 mg/kg | qualified | GB2762 | 0.5 mg/kg | heavy |
| | and | meat | | arsenic | | | | | metals |
| | pot-stewed | with | | (in terms | | | | | and |
| | meat | sauce | | of As) | | | | | other |
| | product | | | | | | | | elemental |
| | | | | | | | | | pollutants |

As can be seen from Table 1, the sampling items of soy-cured and pot-stewed meat products are different in different years. In order to reflect the food safety status of soy-cured and pot-stewed meat products as comprehensively as possible, all items sampled were eventually included in an index system. Taking data from 2014 to 2019 in a province as an example, 28 test items (acid orange II, clenbuterol, chloromycetin, salbutamol, ractopamine, commercial sterility, coliform, total number of colonies, Listeria monocytogenes, benzo[a]pyrene, N-dimethylnitrosamine, nitrite residue (in terms of sodium nitrite), sorbic acid and potassium salt thereof (in terms of sorbic acid), sodium saccharin (in terms of saccharin), dehydroacetic acid and sodium salt thereof (in terms of dehydroacetic acid), benzoic acid and sodium salt thereof (in terms of benzoic acid), carmine, amaranth, new red, sunset yellow, lemon yellow, allura red, erythrosine, the sum of the proportions of respective amounts of preservatives to their maximum amounts when being used in combination, total arsenic (in terms of As), lead (in terms of Pb), chromium (in terms of Cr), cadmium (in terms of Cd)) were included as evaluation indexes, which contain 8 categories: non-edible substances, prohibited veterinary drugs, other microorganisms, pathogenic microorganisms, organic pollutants, other pollutants, food additives, heavy metals and other elemental pollutants. See Table 2.

TABLE 2
Test items of soy-cured and pot-stewed meat
products in a province from 2014 to 2019

| No. | Item Category | Test Item |
|---|---|---|
| 1 | Non-edible | acid orange II |
| | substances | |
| 2 | Prohibited | clenbuterol |
| 3 | veterinary drugs | chloramphenicol |
| 4 | | salbutamol |
| 5 | | ractopamine |
| 6 | Other | commercial sterility |
| 7 | microorganisms | coliform |
| 8 | | total number of colonies |
| 9 | Pathogenic | Listeria monocytogenes |
| | microorganisms | |
| 10 | Organic pollutants | benzo[a]pyrene |
| 11 | Other pollutants | N-dimethylnitrosamine |
| 12 | Food additives | nitrite residue (in terms |
| | | of sodium nitrite) |
| 13 | | sorbic acid and potassium salt |
| | | thereof (in terms of sorbic acid) |
| 14 | | sodium saccharin (in in |
| | | terms of saccharin) |
| 15 | | dehydroacetic acid and sodium |
| | | salt thereof (in terms of |
| | | dehydroacetic acid) |
| 16 | | benzoic acid and sodium salt |
| | | thereof (in terms of |
| | | benzoic acid) |
| 17 | | carmine |
| 18 | | amaranth |
| 19 | | new red |
| 20 | | sunset yellow |
| 21 | | lemon yellow |
| 22 | | allura red |
| 23 | | erythrosine |
| 24 | | the sum of the proportions of |
| | | respective amounts of |
| | | preservatives to their maximum |
| | | amounts when being used in |
| | | combination |
| 25 | Heavy metals | total arsenic (in terms of As) |
| 26 | and other | lead (in terms of Pb) |
| 27 | elemental | chromium (in terms of Cr) |
| 28 | pollutants | cadmium (in terms of Cd)) |

Step 102: performing wavelet decomposition on the historical data for food safety risk level based on Daubechies wavelet basis, to obtain a plurality of historical data components for food safety risk level.

Specifically, since the sampling data for food safety is a non-stationary discrete time series with large amplitude, the learning effect will be poor if it is directly brought into the LSTM model. Time-domain features may be obtained by using wavelet decomposition because of its wavelet basis feature, and thus the wavelet decomposition is more suitable for processing non-stationary signals and may be adopted to decompose and then recombine original series, thereby smoothing the original series.

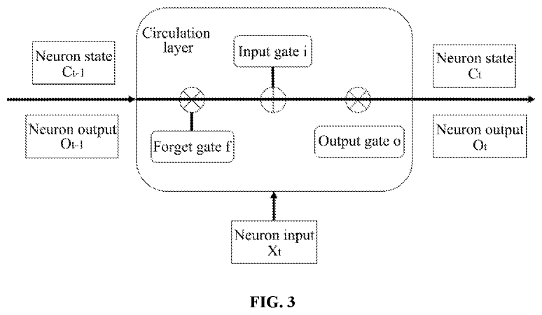

Using wavelet decomposition, the original information may be decomposed into information with different finenesses, where coarse information may represent the trend of the original information, while the detailed information reflects the fluctuation of the original information. Since the sampling data for food safety is a discrete time series, it is decomposed using fast binary orthogonal wavelet decomposition in the discrete wavelet decomposition, and the decomposition diagram is shown in FIG. 2. Such that through transformation, features of certain aspects of the problem may be fully highlighted, and localized analysis of time (space) frequency may be performed. Through a dilation-translation operation, the signal (function) is gradually subjected to multi-scale refinement, and finally, time subdivision at high frequencies and frequency subdivision at low frequencies are achieved. It may automatically adapt to the requirements of time-frequency signal analysis, so that it may focus on any details of the signal.

Since the original data has the characteristics of continuity and large fluctuation, in the present application, the 8-order Daubechies wavelet basis with good smoothness is selected in the process of wavelet decomposition, and the original data are decomposed into sub-series of different frequencies according to the complexity of the data. Each sub-series has a same length as that of the original data, reflecting the information of different frequencies contained in the original series. For example, the decomposed information of levels 3, 4 and 5 after decomposition may reflect the trend characteristics of the original data to different extents, while the other decomposed information reflects different noise disturbance factors. Finally, smooth mode is used for reconstruction.

Step 103: inputting the plurality of historical data components for food safety risk level into an LSTM model and predicting a food safety risk level, to obtain a predicted value of the food safety risk level.

Specifically, an LSTM (Long Short-Term Memory) neural network is a new type of deep machine learning neural network built on RNN (Recurrent Neural Network) and establishes a long time delay between input, feedback and prevention of gradient bursts. This architecture allows its internal states in special memory cells to maintain a continuous stream of errors, where gradients neither burst nor disappear.

The LSTM contains a memory cell that attempts to store information for a long time, and this memory cell is a linear neuron with autologous internal connections. Specifically, three gates are added inside each neuron, namely an input gate, an output gate and a forget gate, which may perform a selectively forgetting operation and a partially or fully accepting operation according to the feedback weight correction, so that not every neuron gets modified, and the gradient does not disappear many times, so that the weights of previous layers may be modified accordingly, and at the same time an error function falls faster with the gradient and converges to an optimal solution more easily. The gradient does not disappear completely no matter how far it propagates. The input gate allows other parts of the neural network to read the memory cell when the output value is 1; while the output gate allows other parts of the neural network to write the content into the memory cell when the output value is 1. When the output of the forget gate is 1, the memory cell writes the content to itself; when the output of the forget gate is 0, the memory cell flushes the previous content. Taking forward pass as an example, the input gate decides when to pass an activation state into the memory cell, while the output gate decides when to pass the activation out of the memory cell, and finally the forget gate is used to learn whether to remember all (or part) of the previous neuron state or to forget it completely. FIG. 3 shows a schematic diagram of an LSTM cycle structure.

The core part therein is the state transfer from neuron Cₜ₋₁ to Cₜ:

Cₜ=f*Cₜ₋₁+i*ΔCₜ

where Cₜ₋₁ is the neuron state at moment t-1, Cₜ is the neuron state at moment t, and ΔCₜ is the neuron information increment at moment t. f and i are the forget gate and the input gate, respectively, and their expressions are as follows.

(1) The expression of the forget gate f:

f=Sigmoid(W_{f}*[Oₜ₋₁,Xₜ]+b_{f})

where Sigmoid is a Sigmoid activation layer such that the output result is a value of 0-1, representing the degree of retention of that information. W_{f} is a weight matrix of the forget gate, Xₜ is the input at moment t, and b_{f} is the bias of the forget gate.

(2) The expression of input gate i:

i=Sigmoid(Wᵢ*[Oₜ₋₁,Xₜ]+bᵢ)

where Wᵢ is the weight matrix of the input gate, bᵢ is the bias of the forget gate, and the rest of the parameters have the same meaning as the forget gate.

(3) The expression of neuron information increment:

ΔCₜ=tanh(W_{c}*[Oₜ₋₁,Xₜ]+b_{c})

where tanh is a tanh activation layer, W_{c} is a weight matrix of the neuron state, b_{c} is the bias of the neuron state, and the rest of the parameters have the same meaning as the forget gate.

The final output is determined by the state Cₜ of the neuron and the output gate o:

Oₜ=o*tanh(Cₜ)

where Oₜ is the output at moment t, o is the output gate, and Cₜ is the neuron state.

The historical data components for food safety risk level of first n soy-cured and pot-stewed meat products are formed into a series which is input into an LSTM network model for training. The model is configured to calculate the effects of safety risk level values of the first n soy-cured and pot-stewed meat products on safety risk level values of subsequent soy-cured and pot-stewed meat products and also consider the effects of the subsequent safety risk level values on the previous safety risk level values during training. The decision to remember or forget is made based on these effects and neuron states are updated in real time.

Alternatively, the neural network used in the present embodiment has 4 layers in total, the first 20 levels of the current risk level to be predicted are used as input features, and the number of neurons in a corresponding input layer is 20; and the current risk level to be predicted is used as an output feature, and the number of neurons in a corresponding output layer is 1. The middle hidden layers are an LSTM layer and a fully connected layer with 16 nodes, respectively. The other parameters of the training set are shown in Table 3.

TABLE 3
Training set parameters

| Split ratio | Size of | | Whether the |
|---|---|---|---|
| of training | training | Training | training set has |
| set to test set | batch | rounds | been scrambled? |
| 2:1 | 64 | 100 | Yes |

In the method according to the present application, historical data for food safety risk level are obtained based on historical test data for food safety, the historical data for food safety risk level are input into an LSTM model for prediction of a food safety risk level, and the prediction of the risk level of food is effectively achieved. Also, considering that the sampling data for food safety is a non-stationary discrete time series with large amplitude, if it is directly brought into the LSTM model, the learning effect will be poor and the prediction accuracy will be affected. Therefore, before being brought into the LSTM model, the historical test data for food safety is preprocessed to be smoothed by wavelet decomposition, thereby further improving the prediction accuracy and providing technical support for the defense and daily monitoring of food safety.

Alternatively, based on the embodiments above, the inputting the plurality of historical data components for food safety risk level into an LSTM model and predicting a food safety risk level, to obtain a predicted value of the food safety risk level includes:

predicting the plurality of historical data components for food safety risk level respectively by the LSTM model, to obtain predicted results of the plurality of historical data components for food safety risk level; and

reconstructing the predicted results of the plurality of historical data components for food safety risk level, to obtain a predicted value of the food safety risk level.

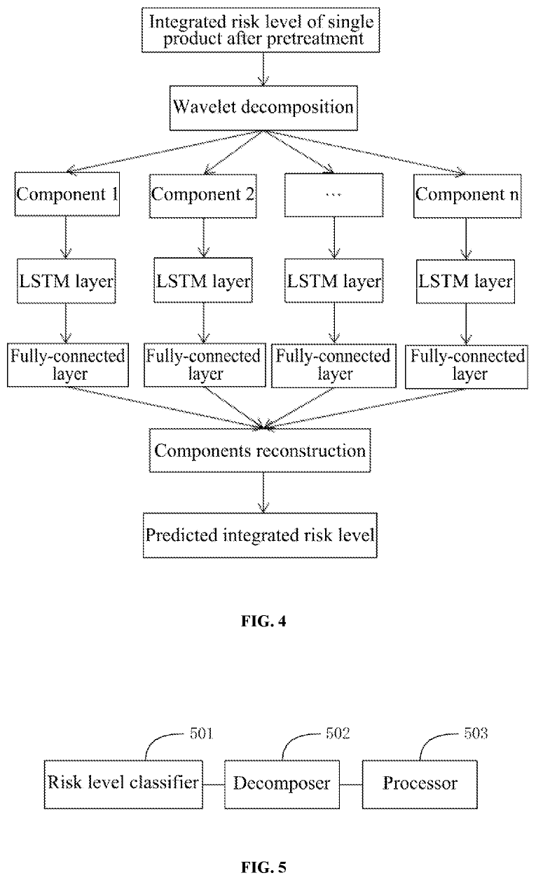

Specifically, as shown in FIG. 4, wavelet decomposition is performed on the historical test data for food safety after being classified into the food safety risk levels, i.e., historical data for food safety risk level, to obtain a plurality of components. The respective components are input into an LSTM model, the LSTM model is configured to predict the plurality of components separately to obtain the prediction results for the respective components, and finally the prediction results for the respective component are reconstructed to output a final prediction result.

In the method according to the present application, the prediction accuracy is further improved by preprocessing the historical test data for food safety to be smoothed through wavelet decomposition before substituting the historical test data for food safety into the LSTM model for prediction.

Alternatively, based on the embodiments above, the classifying food safety risk level based on historical test data for food safety, to obtain historical data for food safety risk level includes:

de-dimensionalizing the historical test data for food safety to obtain de-dimensionalized historical test data for food safety; and

classifying food safety risk level based on the de-dimensionalized historical test data for food safety to obtain historical data for food safety risk level.

Specifically, due to the randomness and non-uniformity of the test results, the learning curve is very complex and prediction results have large deviations if the values of the test results are directly substituted into the model for training. Therefore, the historical test data for food safety is de-dimensionalized to obtain the de-dimensionalized historical test data for food safety; the food safety risk levels are divided based on the de-dimensionalized historical test data for food safety, to obtain the historical data for food safety risk level.

In the method according to the present application, by de-dimensionalizing the historical test data for food safety, the effects of the randomness and non-uniformity of the test results on the prediction accuracy may be effectively prevented.

Alternatively, based on the embodiments above, the food safety risk level is classified into 5 levels;

the classifying food safety risk level based on the de-dimensionalized historical test data for food safety to obtain historical data for food safety risk level can be performed based on the following equation:

$${Y}_{i} = \{ \begin{matrix}{X}_{i} / {X}_{standard} , & when {X}_{standard} is a numerical value , \\ 0 , & when {X}_{standard} is not to be detected or not to be used , and the measured value of the item is not detected \\ 1 , & when {X}_{standard} is not to be detected or not to be used , and the measured value of the item has a numerical value\end{matrix}$$

where Yi is the de-dimensionalized historical test data for food safety, X_{standard} is a standard value specified in the national standards, and Xᵢ is the actual measured value of a test item;

when Yᵢ is greater than or equal to zero and less than or equal to 0.1, the food safety risk level is 1; when Yᵢ is greater than 0.1 and less than or equal to 0.3, the food safety risk level is 2; when Yᵢ is greater than 0.3 and less than or equal to 0.7, the food safety risk level is 3; when Yᵢ is greater than 0.7 and less than 1, the food safety risk level is 4; when Yᵢ is greater than 1, the food safety risk level is 5.

Specifically, according to the de-dimensionalized results, the item risk level is divided into 5 levels, where levels 1-4 meet the national standards, level 1 refers to no warning, level 2 refers to slight warning, level 3 refers to mild warning, level 4 refers to moderate warning, and level 5 does not meet the national standards and refers to severe warning. The food safety risk levels are shown in Table 4.

TABLE 4
Information table of food safety risk level

| | | Early | |
|---|---|---|---|
| Risk | Evaluation | warning | |
| level | value | indicators | Remarks |
| Level 1 | 0 ≤ Yi ≤ 0.1 | no | non-polluting |
| | | warning | |
| Level 2 | 0.1 < Yi ≤ 0.3 | slight | small amount of |
| | | warning | hazardous substances |
| Level 3 | 0.3 < Yi ≤ 0.7 | mild | hazardous substances |
| | | warning | within the acceptable range |
| Level 4 | 0.7 < Yi < 1.0 | moderate | high content of hazardous |
| | | warning | substances is hazardous to |
| | | | health to a certain extent |
| Level 5 | Yi ≥ 1.0 | severe | at least one unqualified |
| | | warning | item which seriously |
| | | | endangers health |

Alternatively, based on the embodiments above, after obtaining historical test data for food safety, and classifying food safety risk level based on the historical test data for food safety to obtain historical data for food safety risk level, the method further includes:

binning the historical data for food safety risk level based on a predetermined time interval to obtain binned historical data for food safety risk level; and

obtaining historical data for integrated risk level of food based on the binned historical data for food safety risk level.

Specifically, due to the randomness of food sampling, the sampling is not performed every day, and there are many default values if modeling is performed by day. Thus, the data needs to be binned. Since a time interval for data binning will affect the number of input points of LSTM and precision, if the time interval is too long (e.g., binning monthly), the number of the input points of LSTM will be too small, resulting in lower model precision; if the time interval is too short, the data will have more default values and the learning curve will be complicated, resulting in a lack of credibility in the final prediction result. In the present embodiment, the time interval for data binning is optimized, and the experiments are conducted with time intervals of 1 day, 4 days, 7 days, 15 days, and 30 days, respectively, as detailed in Table 5.

TABLE 5
Comparison table of time interval and accuracy rate

| Time interval (day) | 1 | 4 | 7 | 15 | 30 |
|---|---|---|---|---|---|
| Accuracy rate | 0.99 | 0.99 | 0.87 | 0.84 | 0.77 |

Through the comparison experiments with different intervals, it can be found that as the sampling interval increases, the average accuracy of the prediction gradually decreases, and the data set also decreases, resulting in too small data set, which fails to meet basic conditions of neural network training for cities with less original data. On the other hand, since the original food safety data has many default values in the time dimension, if the interval adopted is too small, many default values will be collected, making the sampled data unrepresentative and interfering with the prediction. Therefore, the sampling interval is minimized while taking into account the validity of the data. In the present embodiment, the preset time interval is set to be 4 days, i.e., binning is carried out every 4 days.

In the method according to the present application, data binning is adopted to process the historical data for food safety risk level, further effectively preventing the effects of the randomness and non-uniformity of the test results on prediction accuracy.

In an embodiment, based on the embodiments above, the obtaining historical data for integrated risk level of food based on the binned historical data for food safety risk level is calculated by the following equation:

level(A)=argmax[w(i)*eⁱ]+1

where level(A) is an integrated risk level of food A; i is the risk level of food A, and w(i) is a proportion of risk level i in the food A.

Specifically, since test items with low risk levels are in majority, while test items with high risk levels are in minority, but data with high risk levels has a decisive influence on the final food safety risk level, using the traditional weighted average method will result in a low final risk level of food which cannot reflect the true risk level of the food.

Therefore, an integrated risk level of food is calculated based on the equation level(A)=argmax[w(i)*eⁱ]+1 to well reflect the characteristics of the food data and make the calculated risk level more realistic.

The first ⅔ of the data of soy-cured and pot-stewed meat products in a province from 2014-2019 were used as a training set and the last ⅓ thereof were used as a test set to verify the prediction accuracy of the model. The prediction accuracy was calculated as 0.97, which is a proportion of the number of correctly predicted risk levels by statistics to true risk levels in the test samples, specifically. Using a similar method, data of soy-cured and pot-stewed meat products from 30 other provinces and cities across the country were substituted into the LSTM model for training and prediction, all of which have obtained good results, as shown in Table 6 in which the lowest accuracy rate is 0.89 for province X2. The average accuracy rate is 0.95 with a standard deviation of 0.029, indicating that the overall accuracy rate was high and the accuracy rate fluctuated less. It shows that the established LSTM model may be applied to the time-series prediction of the integrated risk level of soy-cured and pot-stewed meat products.

TABLE 6
Prediction accuracy rate of soy-cured and pot-stewed
meat products in provinces and cities across the country

| | Province or | Predicted | Predicted |
|---|---|---|---|
| No. | city name | accuracy rate | risk level |
| 1 | Q | 1.00 | 1 |
| 2 | Z | 1.00 | 1 |
| 3 | S | 0.99 | 1 |
| 4 | G | 0.99 | 4 |
| 5 | E | 0.99 | 1 |
| 6 | N | 0.99 | 3 |
| 7 | L | 0.98 | 4 |
| 8 | Y | 0.98 | 5 |
| 9 | H | 0.97 | 1 |
| 10 | J | 0.97 | 1 |
| 11 | G2 | 0.96 | 1 |
| 12 | H3 | 0.96 | 1 |
| 13 | W | 0.95 | 2 |
| 14 | J2 | 0.95 | 1 |
| 15 | M | 0.95 | 1 |
| 16 | S2 | 0.95 | 1 |
| 17 | X | 0.95 | 3 |
| 18 | Y3 | 0.95 | 1 |
| 19 | D | 0.94 | 1 |
| 20 | Z2 | 0.94 | 1 |

| | | | |
|---|---|---|---|
| 21 | M2 | 0.94 | 1 |
| 22 | Q2 | 0.94 | 4 |
| 23 | J3 | 0.93 | 5 |
| 24 | Q3 | 0.93 | 1 |
| 25 | L2 | 0.93 | 1 |
| 26 | G3 | 0.93 | 4 |
| 27 | J4 | 0.93 | 1 |
| 28 | C | 0.92 | 1 |
| 29 | J5 | 0.91 | 1 |
| 30 | Y4 | 0.91 | 1 |
| 31 | X2 | 0.89 | 1 |

Empirical mode decomposition (EMD) is widely used in signal processing and data analysis. It is designed to decompose a signal wave with irregular frequency into signal waves with different single frequencies and a residual. The signal waves with different single frequencies are also called as intrinsic mode functions (IMF). EMD performs signal decomposition based on the time-scale characteristics of the data itself, i.e., local smoothing, without any predetermined basis functions. It is fundamentally different from the Fourier decomposition and wavelet decomposition methods established on a priori assumptions of harmonic basis functions (or fundamental frequencies) and wavelet basis functions.

After the same data preprocessing, test data of soy-cured and pot-stewed meat products in 31 provinces and cities from 2014 to 2019 were subjected to EMD decomposition, the respective IMFs obtained from the decomposition were used as the input data of LSTM and the accuracy rates were calculated as shown in the table. The lowest accuracy rate was 0.32 found in province J3, the average accuracy rate was 0.625, and the standard deviation was 0.190, as shown in Table 7. Compared with the EMD-LSTM network model, the wavelet decomposition-LSTM network model has a higher accuracy. Further, the prediction accuracy is more stable.

Experiments show that some components obtained by the EMD-LSTM decomposition still have complex variation trends, such as the prediction error of IMF [0] is large, which leads to a large error in the reconstructed result, while the wavelet-LSTM overcomes this problem better because the wavelet-LSTM chooses the db wavelet basis with better smoothness and high-order vanishing moments (Daubechies wavelet basis) instead of the common Haar wavelet basis. Although the calculation amount is increased, it also results in better smoothness of each component obtained by decomposition, so that LSTM has high accuracy for each component.

TABLE 7
Accuracy rate of test data of soy-cured and pot-stewed
meat products from 2014-2019 in provinces and cities

| | Province or | Wavelet decomposition- | EMD-LSTM |
|---|---|---|---|
| No. | city name | LSTM network model | network model |
| 1 | Q | 1.00 | 1 |
| 2 | Z | 1.00 | 0.79 |
| 3 | S | 0.99 | 0.66 |
| 4 | G | 0.99 | 0.78 |
| 5 | E | 0.99 | 0.39 |
| 6 | N | 0.99 | 0.87 |
| 7 | L | 0.98 | 0.51 |
| 8 | Y | 0.98 | 0.48 |
| 9 | H | 0.97 | 0.55 |
| 10 | J | 0.97 | 0.86 |
| 11 | G2 | 0.96 | 0.39 |
| 12 | H3 | 0.96 | 0.58 |
| 13 | W | 0.95 | 0.57 |
| 14 | J2 | 0.95 | 0.86 |
| 15 | M | 0.95 | 0.83 |
| 16 | S2 | 0.95 | 0.51 |
| 17 | X | 0.95 | 0.84 |
| 18 | Y3 | 0.95 | 0.46 |
| 19 | D | 0.94 | 0.68 |
| 20 | Z2 | 0.94 | 0.73 |
| 21 | M2 | 0.94 | 0.52 |
| 22 | Q2 | 0.94 | 0.42 |
| 23 | J3 | 0.93 | 0.32 |
| 24 | Q3 | 0.93 | 0.85 |
| 25 | L2 | 0.93 | 0.4 |
| 26 | G3 | 0.93 | 0.65 |
| 27 | J4 | 0.93 | 0.87 |
| 28 | C | 0.92 | 0.46 |
| 29 | J5 | 0.91 | 0.69 |
| 30 | Y4 | 0.91 | 0.37 |
| 31 | X2 | 0.89 | 0.49 |

A prediction device for food safety risk level according to the present application is described below, and the prediction device for food safety risk level described below and the prediction method for food safety risk level described above may correspond and refer to each other.

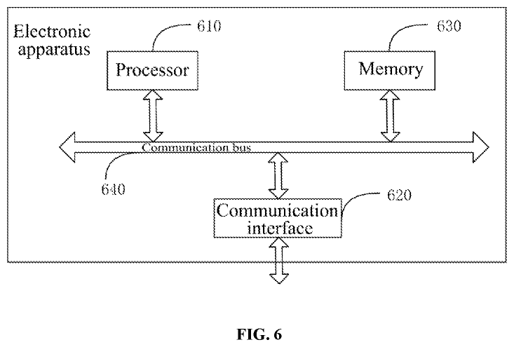

Based on any of the above embodiments, FIG. 5 shows a structural diagram of the prediction device for food safety risk level according to an embodiment of the present application. As shown in FIG. 5, the prediction device for food safety risk level includes a risk level classifier 501, a decomposer 502 and a processor 503.

The risk level classifier 501 is configured to classify food safety risk level based on historical test data for food safety to obtain historical data for food safety risk level; the decomposer 502 is configured to perform wavelet decomposition on the historical data for food safety risk level based on Daubechies wavelet basis to obtain a plurality of historical data components for food safety risk level; and the processor 503 is configured to input the plurality of historical data components for food safety risk level into an LSTM model and predict a food safety risk level to obtain a predicted value of the food safety risk level.

In the device according to the present application, the historical data for food safety risk level are obtained based on the historical test data for food safety, the historical data for food safety risk level are input into an LSTM model for prediction of a food safety risk level, and the prediction of the risk level of food is effectively achieved. Also, considering that the sampling data for food safety is a non-stationary discrete time series with large amplitude, if it is directly brought into the LSTM model, the learning effect will be poor and the prediction accuracy will be affected. Therefore, Therefore, before being brought into the LSTM model for prediction, the historical test data for food safety is smoothed and preprocessed by wavelet decomposition, thereby further improving the prediction accuracy and providing technical support for the defense and daily monitoring of food safety.

Alternatively, based on any of the above embodiments, the processor is configured to input the plurality of historical data components for food safety risk level into an LSTM model and predict a food safety risk level to obtain a predicted value of the food safety risk level, which specifically includes:

predicting, by the LSTM model, the plurality of historical data components for food safety risk level to obtain predicted results of the plurality of historical data components for food safety risk level; and

reconstructing the predicted results of the plurality of historical data components for food safety risk level to obtain a predicted value of the food safety risk level.

Alternatively, based on any of the above embodiments, the classifying food safety risk level based on historical test data for food safety to obtain historical data for food safety risk level includes:

de-dimensionalizing the historical test data for food safety to obtain de-dimensionalized historical test data for food safety; and

classifying food safety risk level based on the de-dimensionalized historical test data for food safety to obtain historical data for food safety risk level.

Alternatively, based on any of the above embodiments, the food safety risk level is classified into 5 levels;

the classifying food safety risk level based on the de-dimensionalized historical test data for food safety to obtain historical data for food safety risk level is specifically:

$${Y}_{i} = \{ \begin{matrix}{X}_{i} / {X}_{standard} , & when {X}_{standard} is a numerical value , \\ 0 , & when {X}_{standard} is not to be detected or not to be used , and the measured value of the item is not detected \\ 1 , & when {X}_{standard} is not to be detected or not to be used , and the measured value of the item has a numerical value\end{matrix}$$

where Yᵢ is the de-dimensionalized historical test data for food safety, X_{standard} is a standard value specified in the national standards, and Xᵢ is the actual measured value of a test item;

when Yᵢ is greater than or equal to zero and less than or equal to 0.1, the food safety risk level is 1; when Yᵢ is greater than 0.1 and less than or equal to 0.3, the food safety risk level is 2; when Yᵢ is greater than 0.3 and less than or equal to 0.7, the food safety risk level is 3; when Yᵢ is greater than 0.7 and less than 1, the food safety risk level is 4; when Yᵢ is greater than 1, the food safety risk level is 5.

Alternatively, based on any of the above embodiments, after obtaining historical test data for food safety, and classifying food safety risk level based on the historical test data for food safety to obtain historical data for food safety risk level, the method further includes:

binning the historical data for food safety risk level based on a predetermined time interval to obtain binned historical data for food safety risk level; and

obtaining historical data for integrated risk level of food based on the binned historical data for food safety risk level.

Alternatively, based on any of the above embodiments, the obtaining historical data for integrated risk level of food based on the binned historical data for food safety risk level is specifically calculated by:

level(A)=argmax[w(i)*eⁱ]+1

where, level(A) is an integrated risk level of food A; i is the risk level of food A, and w(i) is the proportion of risk level i in food A.

The prediction device for food safety risk level in the embodiments of the present application may be configured to perform the technical solutions of the foregoing prediction method for food safety risk level, and the implementation principles and technical effects of the prediction device are similar to those of the prediction method and will not be repeated here.

FIG. 6 is a schematic diagram of the physical structure of an electronic apparatus. As shown in FIG. 6, the electronic apparatus may include a processor 610, a communication interface 620, a memory 630, and a communication bus 640. The processor 610, the communication interface 620, and the memory 630 communicate with each other through the communication bus 640. The processor 610 may call the logic instructions in the memory 630 to execute the step processes provided by the foregoing method embodiments.

In addition, the logic instructions in the memory 630 described above may be implemented in the form of a software functional unit and may be stored in a computer readable storage medium while being sold or used as a separate product. Based on such understanding, the technical solutions of the present application in essence or a part of the technical solutions that contributes to the prior art, or a part of the technical solutions, may be embodied in the form of a software product, which is stored in a storage medium, including several instructions to cause a computer device (which may be a personal computer, server, or network device, etc.) to perform all or part of the steps of the methods described in the respective embodiments of the present application. The storage medium described above includes various media that can store program codes such as U disk, mobile hard disk, read-only memory (ROM), random access memory (RAM), magnetic disk, or optical disk.

In another aspect, an embodiment of the present application also provides a non-transitory computer-readable storage medium storing computer programs thereon, and the computer programs are executed by a processor to perform the step processes of the methods described in various embodiments of the present application.

The device embodiments described above are merely illustrative, wherein the units described as separate components may or may not be physically separate, and the components displayed as units may or may not be physical units, that is, may be located at the same place or be distributed to multiple network units. Some or all of the modules may be selected according to actual needs to achieve the purpose of the solution of the present embodiment. Those of ordinary skill in the art can understand and implement the embodiments described above without paying creative labors.

Through the description of the embodiments above, those skilled in the art can clearly understand that the various embodiments can be implemented by means of software and a necessary general hardware platform, and of course, by hardware. Based on such understanding, the technical solutions of the present application in essence or a part of the technical solutions that contributes to the prior art, or a part of the technical solutions, may be embodied in the form of a software product, which may be stored in a storage medium such as ROM/RAM, magnetic discs, optical discs, etc., and includes several instructions to cause a computer device (which may be a personal computer, server, or network device, etc.) to perform the methods described in various embodiments or a part thereof.

Finally, it should be noted that the above embodiments are only used to explain the technical solutions of the present application, and are not limited thereto; although the present application has been described in detail with reference to the foregoing embodiments, it should be understood by those skilled in the art that they can still modify the technical solutions documented in the foregoing embodiments and make equivalent substitutions to a part of the technical features; these modifications and substitutions do not make the essence of the corresponding technical solutions depart from the spirit and scope of the technical solutions of various embodiments of the present application.

1. A prediction method for food safety risk level, comprising:
classifying food safety risk level based on historical test data for food safety to obtain historical data for food safety risk level;
performing wavelet decomposition on the historical data for food safety risk level based on Daubechies wavelet basis to obtain a plurality of historical data components for food safety risk level; and
inputting the plurality of historical data components for food safety risk level into an LSTM model and predicting a food safety risk level to obtain a predicted value of the food safety risk level.

2. The prediction method for food safety risk level of claim 1, characterized in that the inputting the plurality of historical data components for food safety risk level into an LSTM model and predicting a food safety risk level to obtain a predicted value of the food safety risk level comprises:
predicting, by the LSTM model, the plurality of historical data components for food safety risk level respectively to obtain predicted results of the plurality of historical data components for food safety risk level; and
reconstructing the predicted results of the plurality of historical data components for food safety risk level to obtain a predicted value of the food safety risk level.

3. The prediction method for food safety risk level of claim 1, characterized in that the classifying food safety risk level based on historical test data for food safety to obtain historical data for food safety risk level comprises:
de-dimensionalizing the historical test data for food safety to obtain de-dimensionalized historical test data for food safety; and
classifying food safety risk level based on the de-dimensionalized historical test data for food safety to obtain the historical data for food safety risk level.

4. The prediction method for food safety risk level of claim 3, characterized in that the food safety risk level is classified into 5 levels;
the classifying food safety risk level based on the de-dimensionalized historical test data for food safety to obtain historical data for food safety risk level is specifically:
$${Y}_{i} = \{ \begin{matrix}{X}_{i} / {X}_{standard} , & when {X}_{standard} is a numerical value , \\ 0 , & when {X}_{standard} is not to be detected or not to be used , and the measured value of the item is not detected \\ 1 , & when {X}_{standard} is not to be detected or not to be used , and the measured value of the item has a numerical value\end{matrix}$$
where Yᵢ is the de-dimensionalized historical test data for food safety, X_{standard} is a standard value specified in the national standards, and Xᵢ is an actual measured value of a test item; and
when Yᵢ is greater than or equal to zero and less than or equal to 0.1, the food safety risk level is 1; when Yᵢ is greater than 0.1 and less than or equal to 0.3, the food safety risk level is 2; when Yᵢ is greater than 0.3 and less than or equal to 0.7, the food safety risk level is 3; when Yᵢ is greater than 0.7 and less than 1, the food safety risk level is 4; when Yᵢ is greater than 1, the food safety risk level is 5.

5. The prediction method for food safety risk level of claim 1, characterized in that after obtaining historical test data for food safety, and classifying food safety risk level based on the historical test data for food safety to obtain historical data for food safety risk level, the prediction method further comprises:
binning the historical data for food safety risk level based on a predetermined time interval to obtain binned historical data for food safety risk level; and
obtaining historical data for integrated risk level of food based on the binned historical data for food safety risk level.

6. The prediction method for food safety risk level of claim 5, characterized in that the obtaining historical data for integrated risk level of food based on the binned historical data for food safety risk level is calculated by the following equation:
level(A)=argmax[w(i)*eⁱ]+1
where level(A) is an integrated risk level of food A; i is the risk level of food A, and w(i) is a proportion of risk level i in food A.

7. A prediction device for food safety risk level, comprising:
a risk level classifier configured to classify food safety risk level based on historical test data for food safety to obtain historical data for food safety risk level;
a decomposer configured to perform wavelet decomposition on the historical data for food safety risk level based on Daubechies wavelet basis to obtain a plurality of historical data components for food safety risk level; and
a processor configured to input the plurality of historical data components for food safety risk level into an LSTM model and predict a food safety risk level to obtain a predicted value of the food safety risk level.

8. The prediction device for food safety risk level of claim 7, characterized in that the processor is configured to input the plurality of historical data components for food safety risk level into an LSTM model and predict a food safety risk level to obtain a predicted value of the food safety risk level, which specifically comprises:
predicting, by the LSTM model, the plurality of historical data components for food safety risk level respectively to obtain predicted results of the plurality of historical data components for food safety risk level; and
reconstructing the predicted results of the plurality of historical data components for food safety risk level to obtain a predicted value of the food safety risk level.

9. An electronic apparatus, comprising a memory, a processor, and computer programs stored on the memory and executable on the processor, characterized in that the processor is configured to implement steps of the prediction method for food safety risk level of claim 1 when executing the computer programs.

10. A non-transitory computer-readable storage medium, on which computer programs are stored, characterized in that steps of the prediction method for food safety risk level of claim 1 are implemented when the computer programs are executed by a processor.

11. An electronic apparatus, comprising a memory, a processor, and computer programs stored on the memory and executable on the processor, characterized in that the processor is configured to implement steps of the prediction method for food safety risk level of claim 2 when executing the computer programs.

12. An electronic apparatus, comprising a memory, a processor, and computer programs stored on the memory and executable on the processor, characterized in that the processor is configured to implement steps of the prediction method for food safety risk level of claim 3 when executing the computer programs.

13. An electronic apparatus, comprising a memory, a processor, and computer programs stored on the memory and executable on the processor, characterized in that the processor is configured to implement steps of the prediction method for food safety risk level of claim 4 when executing the computer programs.

14. An electronic apparatus, comprising a memory, a processor, and computer programs stored on the memory and executable on the processor, characterized in that the processor is configured to implement steps of the prediction method for food safety risk level of claim 5 when executing the computer programs.

15. An electronic apparatus, comprising a memory, a processor, and computer programs stored on the memory and executable on the processor, characterized in that the processor is configured to implement steps of the prediction method for food safety risk level of claim 6 when executing the computer programs.

16. A non-transitory computer-readable storage medium, on which computer programs are stored, characterized in that steps of the prediction method for food safety risk level of claim 2 are implemented when the computer programs are executed by a processor.

17. A non-transitory computer-readable storage medium, on which computer programs are stored, characterized in that steps of the prediction method for food safety risk level of claim 3 are implemented when the computer programs are executed by a processor.

18. A non-transitory computer-readable storage medium, on which computer programs are stored, characterized in that steps of the prediction method for food safety risk level of claim 4 are implemented when the computer programs are executed by a processor.

19. A non-transitory computer-readable storage medium, on which computer programs are stored, characterized in that steps of the prediction method for food safety risk level of claim 5 are implemented when the computer programs are executed by a processor.

20. A non-transitory computer-readable storage medium, on which computer programs are stored, characterized in that steps of the prediction method for food safety risk level of claim 6 are implemented when the computer programs are executed by a processor.
